(19) United States
(12) Patent Application Publication
(10) Pub. No.: US 2018/0191895 A1
(43) Pub. Date: Jul. 5, 2018

(54) PHONE CALL PROCESSING METHOD AND APPARATUS

(71) Applicant: BOE TECHNOLOGY GROUP CO., LTD., Beijing (CN)

(72) Inventors: Junjie ZHAO, Beijing (CN); Zhiqiang QIANG, Beijing (CN); Zhenpeng GUO, Beijing (CN)

(21) Appl. No.: 15/803,348

(22) Filed: Nov. 3, 2017

(30) Foreign Application Priority Data
Jan. 4, 2017 (CN) 201710004525.6

(51) Int. Cl. H04M 3/436; H04M 1/56; H04M 1/725; H04M 3/42; G06F 3/0488; H04W 4/16

(52) U.S. Cl. CPC H04M 3/436; H04M 1/56; H04W 4/16; H04M 3/42382; G06F 3/04883; H04M 1/72522

(57) ABSTRACT

The present disclosure provides a phone call processing method and a phone call processing apparatus. The phone call processing method includes: acquiring a movement track of a target; determining a message instruction corresponding to the movement track of the target; and sending the message instruction and hanging up a phone call.

### CROSS-REFERENCE TO RELATED APPLICATIONS

The present application claims the priority of Chinese Patent Application No. 201710004525.6, filed on Jan. 4, 2017, at China Intellectual Property Office, the contents of which are incorporated herein in their entirety by reference.

### TECHNICAL FIELD

The present application relates to the field of mobile communication technology, and in particular relates to a phone call processing method and a phone call processing apparatus.

### BACKGROUND

In an existing mobile communication terminal, when a user is not available to answer a phone call, he/she may usually choose to hang up the phone, and can inform the caller of a reason for hanging up only by means of writing a message. Likewise, when a user is calling a contact person or talking with a contact person on the phone, if the user chooses to hang up, he/she can inform the contact person of matters concerned with the call or a reason for hanging up only by means of writing a message. Such operations are very troublesome.

### SUMMARY

The present disclosure provides a phone call processing method and a phone call processing apparatus which quickly trigger preset different message instructions by different target movement tracks, such as sliding in different directions on a touch screen of a mobile terminal, different gesture motions, different eve motions or different face motions etc., so as to: in a case where it is not convenient to answer an incoming call, hang up the phone and inform a counterpart user about a reason for hanging up; in a case where an outgoing call is hung up, inform the counterpart user of basic information on the caller; or in a case where the phone is hung up during a conversation because of a particular situation, inform the counterpart user of a reason for hanging up.

According to an aspect of the present disclosure, there is provided a phone call processing method, comprising: acquiring a movement track of a target; determining a message instruction corresponding to the movement track of the target; and sending the message instruction and hanging up the phone call.

According to an embodiment of the present disclosure, the step of determining the message instruction corresponding to the movement track of the target may comprise: determining the corresponding message instruction according to a part of the movement track of the target or the entire movement track of the target.

According to an embodiment of the present disclosure, the method may further comprise, before the step of acquiring the movement track of the target, receiving a request for setting up a call connection, or sending a request for setting up a call connection.

According to an embodiment of the present disclosure, the method may further comprise, before the step of acquiring the movement track of the target, setting a correspondence relationship between the movement track and the message instruction.

According to an embodiment of the present disclosure, the movement track may comprise at least one of a one-dimensional (1D) movement track, a two-dimensional (2D) movement track, and a three-dimensional (3D) movement track.

According to an embodiment of the present disclosure, the message instruction may comprise at least one of a text, a voice and a picture.

According to an embodiment of the present disclosure, the method may further comprise: confirming that the message instruction is receivable by a receiver.

According to an embodiment of the present disclosure, sending the message instruction may be for indicating a reason for hanging up the phone call.

According to another aspect of the present disclosure, there is provided a phone call processing apparatus comprising: a detection circuit, configured to detect a movement track of a target; a determination circuit, configured to determine a message instruction corresponding to the movement track of the target; and a message processing circuit, configured to send the message instruction and hang up the phone call.

According to an embodiment of the present disclosure, the apparatus may further comprise: a call connection setup circuit, configured to receive a request for setting up a call connection, or to send a request for setting up a call connection.

According to an embodiment of the present disclosure, the apparatus may further comprise: a setting circuit, configured to set a correspondence relationship between the movement track and the message instruction.

According to an embodiment of the present disclosure, the apparatus may further comprise: a confirmation circuit, configured to confirm that the message instruction is receivable by a receiver.

### BRIEF DESCRIPTION OF THE FIGURES

In order to more clearly illustrate technical solutions in embodiments of the present disclosure, embodiments of the present disclosure are described below in conjunction with the accompanying drawings. It should be apparent that the following drawings are provided merely for describing some embodiments of the present disclosure, rather than limiting a scope of the present disclosure. An ordinary person skilled in the art may further obtain other implementations, without making inventive effort, according to these drawings, in which:

FIG. 1 shows a display interface of a mobile terminal in a state of incoming call in the prior art;

FIG. 2 shows a display interface of a mobile terminal in a state of outgoing call in the prior art;

FIG. 3 is a schematic flow chart of a phone call processing method according to an embodiment of the present application;

FIG. 4 is a schematic diagram of performing a phone call processing according to a sliding track, according to an embodiment of the present application;

FIG. 5 is a schematic diagram of performing a phone call processing according to a gesture motion, according to an embodiment of the present application;

FIG. 6 is a schematic diagram of performing a phone call processing according to a sliding motion track, according to an embodiment of the present application;

FIGS. 7 to 10 are schematic flow charts of phone call processing methods according to other embodiments of the present application; and

FIGS. 11 to 14 are schematic diagrams of structures of phone call processing apparatuses according to embodiments of the present application.

### DETAILED DESCRIPTION

In order to present technical principles, characteristics and technical effects of the technical solutions of the present application with better clarity, the technical solutions of the present application are set forth in detail below in conjunction with specific embodiments.

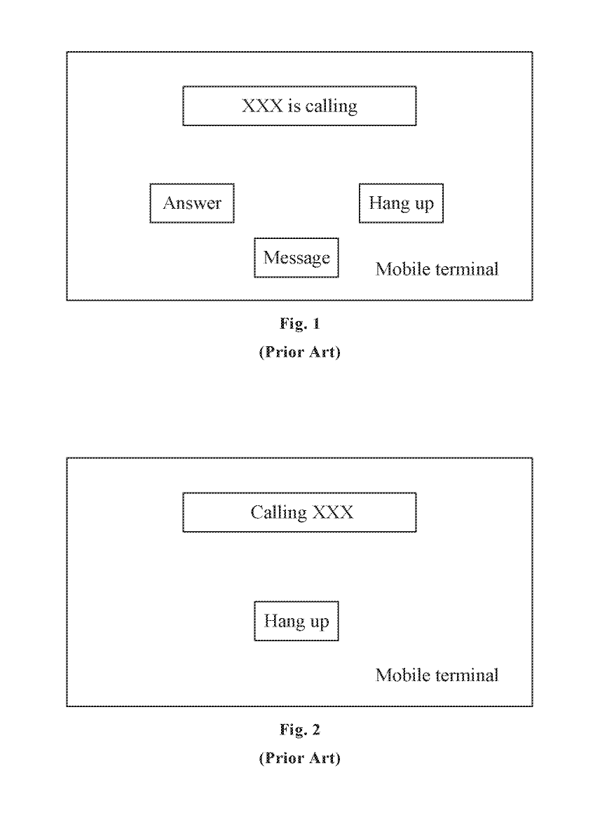

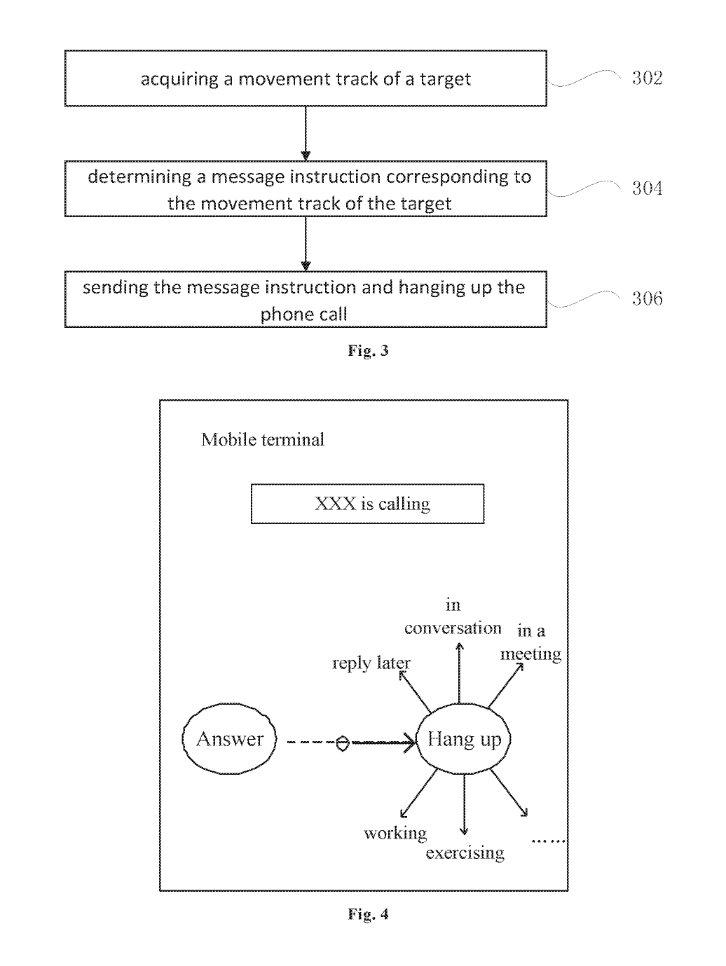

In the prior art, when there is an incoming call, a mobile communication terminal generally displays three options: “answer”, “hang up” and “message”, as shown in FIG. 1. When a user is not available to answer the incoming call, he/she may tap the “message” icon to select a preset message such as “in a meeting”, “reply later”, etc. for a quick response and hang up the phone. In the above phone call processing method, multiple steps are required for completing the operation of sending a message and hanging up. In addition, when the user is calling another user, the mobile communication terminal generally displays only one option of “hang up”, as shown in FIG. 2. If the call has not been connected, usually it can only be ended by a selection of the “hang up” option, and it is impossible to conveniently notify the other user about information relating to the caller and a purpose of this call.

To this end, the present disclosure provides a phone call processing method, so as to send corresponding instruction information to the counterpart user while hanging up the phone.

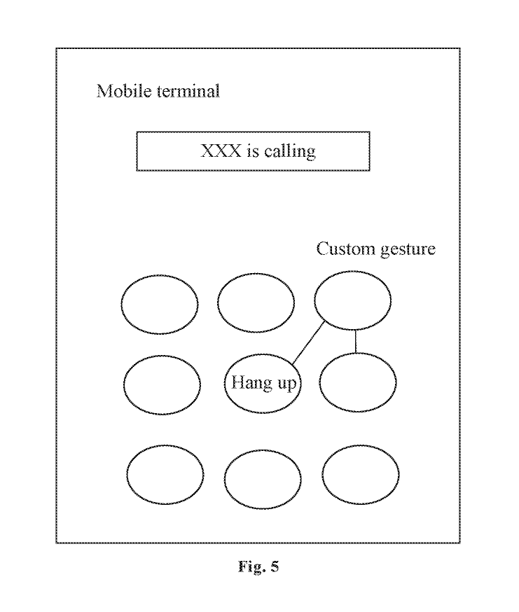

FIG. 3 is a schematic flow chart of a phone call processing method according to an embodiment of the present application. As shown in FIG. 3, the phone call processing method according to an embodiment of the present application includes:

Step 302: acquiring a movement track of a target.

The target may be a finger (or a touch pen) of a user, and the movement track thereof may be a sliding track on a touch screen. In addition, the target may also be an eyeball or a face or the like of a user.

According to an embodiment of the present disclosure, positions on the touch screen at which the user's finger is located at different times may be acquired by the touch screen on a mobile communication terminal, and thereby a movement track of the user's finger may be acquired, such as a track of sliding to the left, a track of sliding to the right or the like. According to another embodiment of the present disclosure, positions in an image at which the user's body part such as finger, eyeball, face or the like is located at different times may be acquired by a video capturing device, and thereby a movement track of the user's finger, eyeball, face or the like may be acquired, such as a track of leftward movement of the finger, a track of rightward movement of the finger, a track of leftward movement of the eyeball, a track of rightward movement of the eyeball, a track of upward movement of the face, or the like.

According to an embodiment of the present disclosure, the movement track of the target may be at least one of a one-dimensional (1D) movement track, a two-dimensional (2D) movement track, and a three-dimensional (3D) movement track. For example, the 1D movement track may be a track in which the user's finger (or touch pen) slides on the touch screen, the 2D movement track may be a track of the user's gesture motion, and the 3D movement track may be a movement track of the user's eyeball or face or the like.

The method further includes Step 304: determining a message instruction corresponding to the movement track of the target.

The corresponding message instruction may refer to a message instruction determined based on a preset correspondence relationship between movement tracks of the target and message instructions. For example, sliding a finger (or touch pen) to the upper right of the touch screen may correspond to a message instruction of “in a meeting”, sliding to the upper left may correspond to a message instruction of “reply later”, and so on. A message instruction corresponding to a movement track of the target may be found according to the preset correspondence relationship between the movement track of the target and the message instruction.

According to an embodiment of the present disclosure, determining the message instruction corresponding to the movement track of the target may include: determining the corresponding message instruction according to a part of or the entire movement track of the target. The part may be a former part, a middle part or a latter part of the movement track. A mobile terminal in the prior art may realize making a call or hanging up a call by sliding a finger (or touch pen) on a touch screen or by a gesture motion. According to an embodiment of the present disclosure, the movement track of the target may be one in which a movement track corresponding to a message instruction is combined with an existing sliding track or a gesture motion or the like that directly hangs up the call.

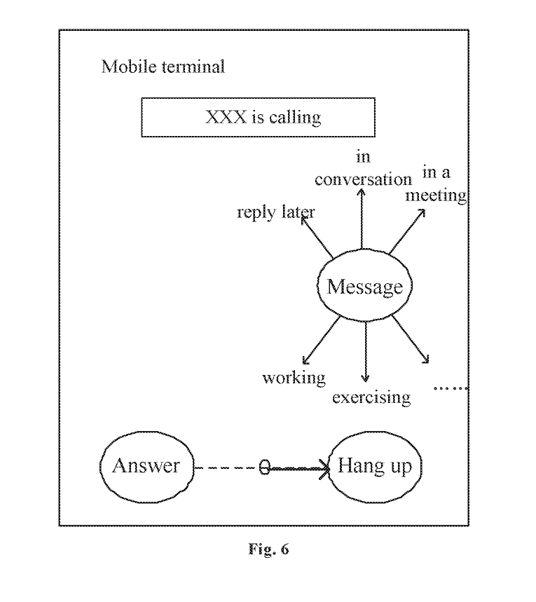

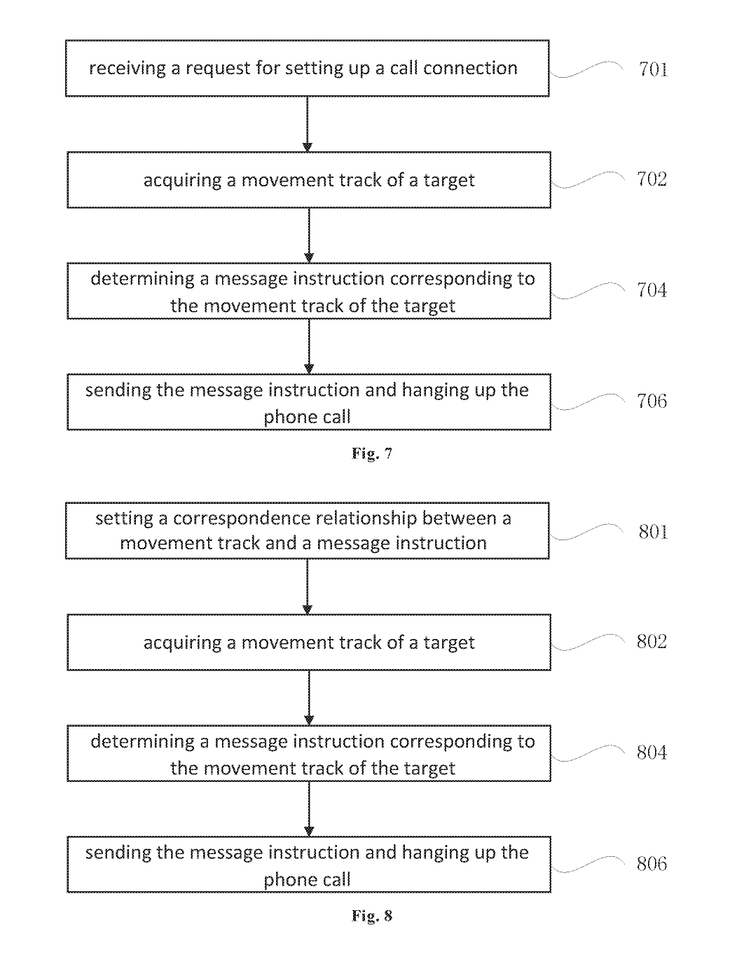

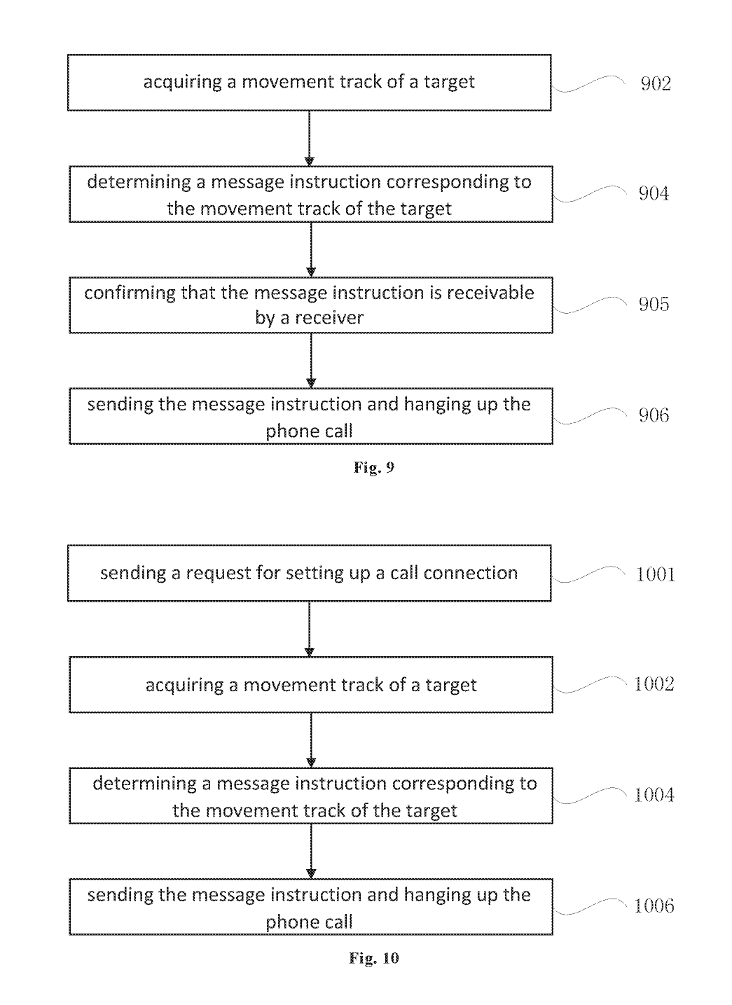

FIG. 4 is a schematic diagram of performing a phone call processing according to a sliding track, according to an embodiment of the present application, FIG. 5 is a schematic diagram of performing a phone call processing according to a gesture motion, according to an embodiment of the present application, and FIG. 6 is a schematic diagram of performing a phone call processing according to a sliding motion track, according to an embodiment of the present application.

As shown in FIG. 4, the sliding track includes a former part in which a finger moves to the right to hang up the call and a latter part in which the finger slides towards a certain preset direction to send a corresponding message instruction. As shown in FIG. 5, the gesture motion includes a former part of tapping the “hang up” button and a latter part of forming a pattern by sliding, and a corresponding message instruction may be sent according to the pattern formed by sliding in the latter part. In addition, the movement track may be a movement track independent of the existing sliding or gesture motion or the like that can directly hang up the call. As shown in FIG. 6, the phone may be hung up by moving a finger to the right, and a corresponding message instruction may be sent by a movement track of the target moving relative to the “message” button.

The method further includes Step 306: sending the message instruction and hanging up a phone call.

According to an embodiment of the present disclosure, the call may be a received request for setting up a call connection, may be a sent request for setting up a call connection, and may also be a call connection already set up. The message instruction determined in Step 304 may be sent to a counterpart user of the call while the call is hung up.

The message instruction may be at least one of a text, a voice and a picture, and may express a reason for hanging up such as “in a meeting”, “reply later” and the like. A means for sending the message may be one provided by a telecom service provider, such as a short message, a multimedia message and the like, or may also be instant messaging, for example, by a WeChat APP etc., provided by a network service provider.

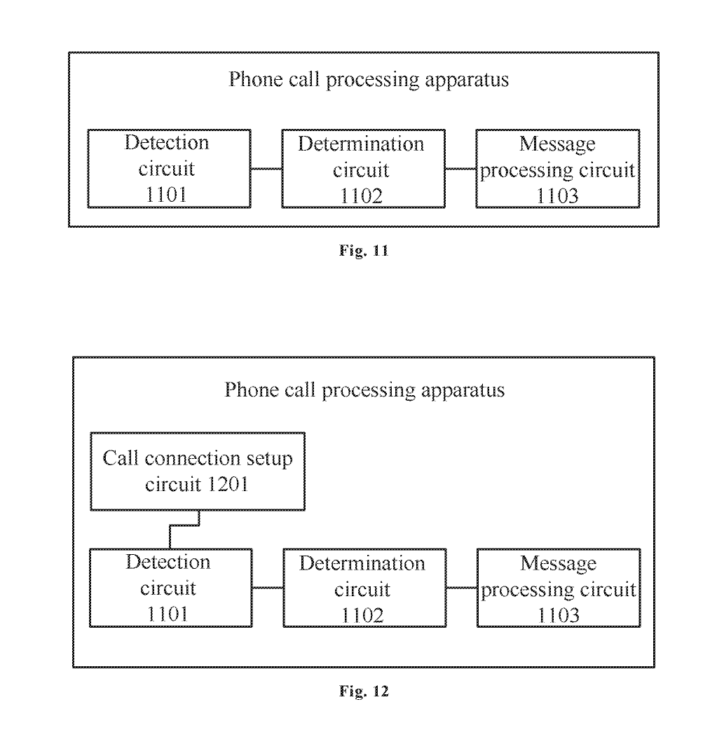

FIGS. 7 to 10 are schematic flow charts of phone call processing methods according to other embodiments of the present application.

As shown in FIG. 7, a phone call processing method according to the present embodiment may be applied to a case of hanging up an incoming call. Compared to the embodiment described with reference to FIG. 3, the method further includes:

Step 701: receiving a request for setting up a call connection.

The request for setting up a call connection may be a request for setting up a call connection based on a calling service provided by a telecom service provider, for example, a request for setting up a call connection from another mobile terminal in the network initiated by dialing a phone number, and may also be a request for call connection based on a calling service provided by a network service provider, for example, a request for setting up a call connection initiated by an instant messaging software.

Steps 702 to 706 are substantially the same as Steps 302 to 306 in the embodiment described with reference to FIG. 3, respectively, and detailed descriptions thereof are omitted herein.

As shown in FIG. 8, compared to the embodiment described with reference to FIG. 3, the method also includes:

Step 801: setting a correspondence relationship between a movement track and a message instruction.

For example, sliding a finger (or touch pen) towards upper right of the touch screen may correspond to a message instruction of “in a meeting”, sliding towards upper left may correspond to a message instruction of “reply later”, or a gesture of waving one hand (or a gesture of making a fist, or the like) may correspond to a message instruction of “Please contact via message”, or moving an eyeball to the right side (or blinking an eye twice consecutively, or the like) may correspond to a message instruction of “in driving”, and so on. According to teachings of the present application, one skilled in the art may readily conceive various movement tracks and corresponding message instructions thereof according to practical application scenarios.

According to an embodiment of the present disclosure, different types of movement tracks of a target may correspond to one and the same message instruction.

Steps 802 to 806 are substantially the same as Steps 302 to 306 in the embodiment described with reference to FIG. 3, respectively, and detailed descriptions thereof are omitted herein.

As shown in FIG. 9, compared to the embodiment described with reference to FIG. 3, the method also includes:

Step 905: confirming that the message instruction is receivable by a receiver.

It may be determined whether the receiver is a mobile phone or fixed-line telephone by a phone number of the receiver. By this step, the message instruction may be sent only in a case where the receiver is capable of receiving the message instruction, to prevent unnecessarily sending the message instruction. If it is determined that the receiver cannot receive the message instruction, then the call is hung up without sending the message instruction.

Steps 902, 904 and 906 are substantially the same as Steps 302 to 306 in the embodiment described with reference to FIG. 3, respectively, and detailed descriptions thereof are omitted herein.

As shown in FIG. 10, the phone call processing method according to the present embodiment may be applied to a case of hanging up an outgoing call. Compared to the embodiment described with reference to FIG. 3, the method also includes:

Step 1001: sending a request for setting up a call connection.

The request for setting up a call connection may be a request for setting up a call connection based on a calling service provided by a telecom service provider, and may also be a request for call connection based on a calling service provided by a network service provider. After sending the request for setting up a call connection, a state of the receiver may be a “not connected” state, a “no response” state, a “hung up after being connected” state or a “hung up after a short response” state.

Steps 1002 to 1006 are substantially the same as Steps 302 to 306 in the embodiment described with reference to FIG. 3, respectively, and detailed descriptions thereof are omitted herein.

It is to be noted that in a case of making a request for setting up a call connection and then hanging up, the message instruction may express “XXX has called”, “Please reply on receipt”, or the like. In addition, the message instruction may also indicate a reason for hanging up.

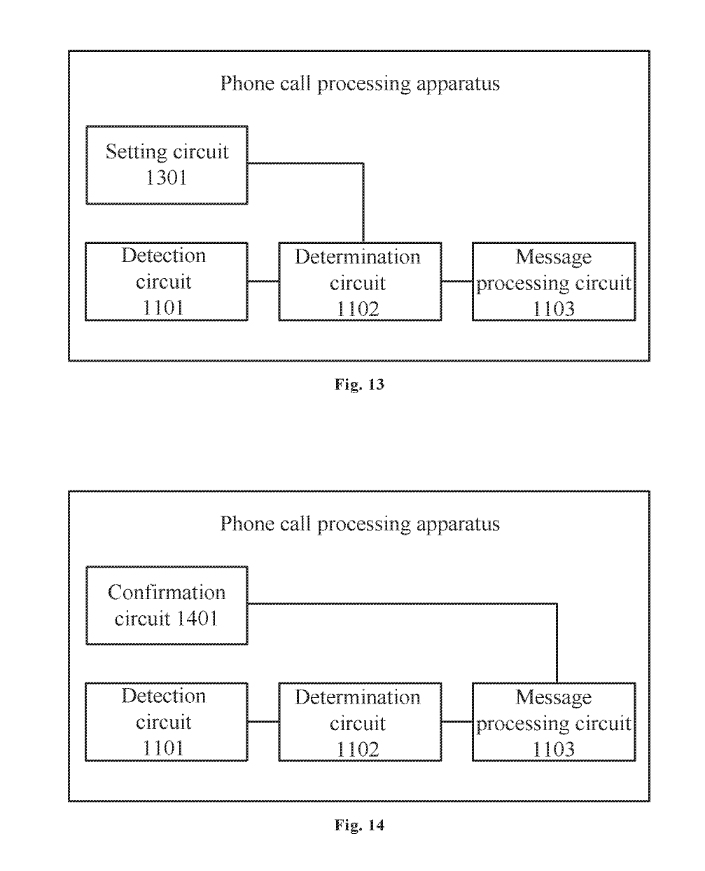

FIGS. 11 to 14 are schematic diagrams of structures of phone call processing apparatuses according to embodiments of the present application.

As shown in FIG. 11, a phone call processing apparatus according to an embodiment of the present application may include a detection circuit 1101, a determination circuit 1102 and a message processing circuit 1103.

The detection circuit 1101 is configured to detect a movement track of a target, for example, to obtain a sliding track of a user's finger (or touch pen) on a touch screen, or an action such as the user's gesture, eye motion, face motion and the like. The determination circuit 1102 is configured to determine a message instruction corresponding to the movement track of the target, for example, to determine a message instruction corresponding to the movement track detected by the detection circuit 1101, according to a preset relationship between a movement track of the target and a message instruction. The message processing circuit 1103 is configured to send the message instruction determined by the determination circuit 1102 and hang up a phone call.

As shown in FIG. 12, compared to the embodiment described with reference to FIG. 11, the phone call processing apparatus according to the present embodiment may further include a call connection setup circuit 1201 configured to receive a request for setting up a call connection, or to send a request for setting up a call connection. The detection circuit 1101 may detect the movement track of the target based on a call set up by the call connection setup circuit 1201.

As shown in FIG. 13, compared to the embodiment described with reference to FIG. 11, the phone call processing apparatus according to the present embodiment may further include a setting circuit 1301, configured to set a correspondence relationship between a movement track and a message instruction. The determination circuit 1102 may determine a message instruction corresponding to the movement track detected by the detection circuit 1101 based on the correspondence relationship between the movement track and the message instruction set by the setting circuit 1301.

As shown in FIG. 14, compared to the embodiment described with reference to FIG. 11, the phone call processing apparatus according to the present embodiment may further include a confirmation circuit 1401, configured to confirm that the message instruction is receivable by a receiver. After the confirmation circuit 1401 confirms that the message instruction is receivable by a receiver, the message processing circuit 1103 sends the message instruction determined by the determination circuit 1102 and hangs up the call. If the confirmation circuit 1401 confirms that the message instruction is not receivable by a receiver, then the message processing circuit 1103 only hangs up the call without sending the message instruction.

It should be appreciated that circuits or steps of the present disclosure may be implemented using a universal computing device. Optionally, they may be implemented using program codes executable by a computing device, so that they can be stored in a storage device and executed by the computing device; and in some cases, steps as illustrated or described may be performed in a different order than that disclosed herein, or they may be implemented by respective integrated circuit modules, or multiple modules or steps may be implemented by a single integrated circuit module. Thus, the present disclosure is not limited to any particular combination of hardware and software. In addition, technical features described for an embodiment may be applied to other embodiments.

The above is intended only to describe embodiments of the present disclosure, and not to limit the scope of the present disclosure. Any modification, equivalent alternative, improvement etc. falling within the spirit and principle of the present disclosure should all be included in the protection scope of the present disclosure.

1. A phone call processing method, comprising:
acquiring a movement track of a target;
determining a message instruction corresponding to the movement track of the target; and
sending the message instruction and hanging up the phone call.

2. The phone call processing method according to claim 1, wherein the step of determining the message instruction corresponding to the movement track of the target comprises:
determining the corresponding message instruction according to a part of the movement track of the target or the entire movement track of the target.

3. The phone call processing method according to claim 1, further comprising, before the step of acquiring the movement track of the target,
receiving a request for setting up a call connection, or sending a request for setting up a call connection.

4. The phone call processing method according to claim 1, further comprising, before the step of acquiring the movement track of the target,
setting a correspondence relationship between the movement track and the message instruction.

5. The phone call processing method according to claim 1, wherein the movement track comprises at least one of a one-dimensional (1D) movement track, a two-dimensional (2D) movement track, and a three-dimensional (3D) movement track.

6. The phone call processing method according to claim 1, wherein the message instruction comprises at least one of a text, a voice and a picture.

7. The phone call processing method according to claim 1, further comprising:
confirming that the message instruction is receivable by a receiver.

8. The phone call processing method according to claim 1, wherein sending the message instruction is for indicating a reason for hanging up the phone call.

9. A phone call processing apparatus comprising:
a detection circuit, configured to detect a movement track of a target;
a determination circuit, configured to determine a message instruction corresponding to the movement track of the target; and
a message processing circuit, configured to send the message instruction and hang up the phone call.

10. The phone call processing apparatus according to claim 9, further comprising:
a call connection setup circuit, configured to receive a request for setting up a call connection, or to send a request for setting up a call connection.

11. The phone call processing apparatus according to claim 9, further comprising:
a setting circuit, configured to set a correspondence relationship between the movement track and the message instruction.

12. The phone call processing apparatus according to claim 9, further comprising:
a confirmation circuit, configured to confirm that the message instruction is receivable by a receiver.

13. The phone call processing apparatus according to claim 9, wherein sending the message instruction is for indicating a reason for hanging up the phone call.
